(19) United States
(12) Patent Application Publication
(10) Pub. No.: US 2026/0270838 A1
(43) Pub. Date: Sep. 10, 2026

(54) BATTERY COMMUNICATION SYSTEM AND OPERATION METHOD THEREOF

(71) Applicant: Grace Connection Microelectronics Limited, Zhubei City (TW)

(72) Inventors: PEI WEI CHEN, Zhubei City (TW); Hsien-Ku CHEN, Zhubei City (TW)

(73) Assignee: Grace Connection Microelectronics Limited, Zhubei City (TW)

(21) Appl. No.: 19/554,674

(22) Filed: Mar. 3, 2026

(30) Foreign Application Priority Data
Mar. 4, 2025 (TW) 114107888

(51) Int. Cl. H04W 40/02

(52) U.S. Cl. CPC H04W 40/02

(57) ABSTRACT

A battery communication system and an operation method thereof are provided. The battery communication system is used to communicate with multiple battery units through a master wireless communication unit and several slave wireless communication units. Each of the battery units is connected to corresponding one of the slave wireless communication units. The operation method of the battery communication system includes the following steps: first, determining whether a specific triggering condition is satisfied in a wireless daisy chain communication path of the battery communication system. When the specific triggering condition is satisfied, establishing a broadcast communication path at the master wireless communication unit, or establishing a jumping communication path between non-adjacent ones of the slave wireless communication units.

### CROSS REFERENCE

The present invention claims priority to TW114107888 filed on Mar. 4, 2025.

### BACKGROUND OF THE INVENTION

### Field of Invention

The present invention relates to a communication system and an operation method thereof, and more particularly to a battery communication system and an operation method thereof.

### Description of Related Art

To improve the efficiency of battery energy storage systems, most industrial and automotive battery packs are currently arranged in series configurations. As more batteries are connected in series, the DC voltage across the battery packs increases. Thus, the battery energy storage system must monitor and collect information such as the voltage and temperature of each battery in order to maintain proper operation and operational safety. As the voltage across the battery communication system increases, which creates growing challenges for the safety and stability of the battery communication system.

With the popular application of lithium iron phosphate batteries, their relatively smooth discharge curve has allowed the capacity of individual batteries to work from only a few ampere-hours (2–3 Ah) to several hundred ampere-hours (200–300 Ah), making more precise battery monitoring parameters necessary for battery energy storage systems. Currently, the battery energy storage systems transmit battery monitoring information by the battery communication systems so that the operating status of each battery can be tracked. However, every node along the communication path must operate properly. When a communication failure occurs at any one node, it can significantly reduce the communication efficiency of the entire battery system.

### SUMMARY OF THE INVENTION

The present invention relates to a battery communication system and an operation method thereof. The system employs a combination of a whisper communication path and a broadcast communication path (or a jumping communication path). When a battery is damaged, so that a communication abnormality occurs, an alternative communication path is available to maintain normal operation.

According to one aspect of the present invention, an operation method of a battery communication system is provided. The battery communication system is used to communicate with multiple battery units through a master wireless communication unit and several slave wireless communication units. Each battery unit is connected to a corresponding slave wireless communication unit. The operation method of the battery communication system includes the following steps: determining whether a specific triggering condition is satisfied in a wireless daisy chain communication path of the battery communication system; when the specific triggering condition is satisfied, establishing at least one broadcast communication path at the master wireless communication unit, or establishing at least one jumping communication path between non-adjacent two of the slave wireless communication units.

According to another aspect of the present invention, a battery communication system is provided. The battery communication system includes multiple battery units, multiple slave wireless communication units, and a master wireless communication unit. Each of the slave wireless communication units is connected to a corresponding battery unit. The master wireless communication unit and the slave wireless communication units are wirelessly connected in series to form a wireless daisy chain communication path. When a specific triggering condition is satisfied, at least one broadcast communication path is established at the master wireless communication unit, or at least one jumping communication path is established between non-adjacent two of the slave wireless communication units.

For a better understanding of the above and other aspects of the present invention, exemplary embodiments are described below with reference to the associated drawings.

### BRIEF DESCRIPTION OF THE DRAWINGS

FIG. 1 shows a schematic diagram illustrating a battery communication system according to one embodiment of the present invention.

FIG. 2 illustrates a fault condition of the battery communication system according to one embodiment of the present invention.

FIG. 3 illustrates another fault condition of the battery communication system according to one embodiment of the present invention.

FIG. 4 is a flowchart illustrating an operation method of the battery communication system according to one embodiment of the present invention.

FIG. 5 illustrates one example of the operation method of the battery communication system shown in FIG. 4.

FIG. 6 illustrates another example of the operation method of the battery communication system shown in FIG. 4.

FIG. 7 illustrates another example of implementing the operation method of the battery communication system shown in FIG. 4.

FIG. 8 illustrates another example of the operation method of the battery communication system shown in FIG. 4.

FIG. 9 illustrates another example of the operation method of the battery communication system shown in FIG. 4.

FIG. 10 illustrates another example of the operation method of the battery communication system shown in FIG. 4.

FIG. 11 illustrates another example of the operation method of the battery communication system shown in FIG. 4.

FIG. 12 is a flowchart illustrating an operation method of a battery communication system according to another embodiment of the present invention.

FIG. 13 illustrates one example of implementing the operation method of the battery communication system shown in FIG. 12.

### DESCRIPTION OF THE PREFERRED EMBODIMENTS

The objectives, technical details, features, and effects of the present invention can be better understood with regard to the detailed description of the embodiments below, with reference to the associated drawings. The technical wordings/terms in this specification are based on a customary understanding of the art. In this specification, the interpretations of these wordings/terms are preferentially based on the description or the definition in this specification. Each embodiment of the present invention includes at least one technical feature. To the extent possible as needed, a person having ordinary knowledge in the art may, select, combine, or modify some or all of the technical features in any one of the embodiments, within the spirit and scope of the present invention.

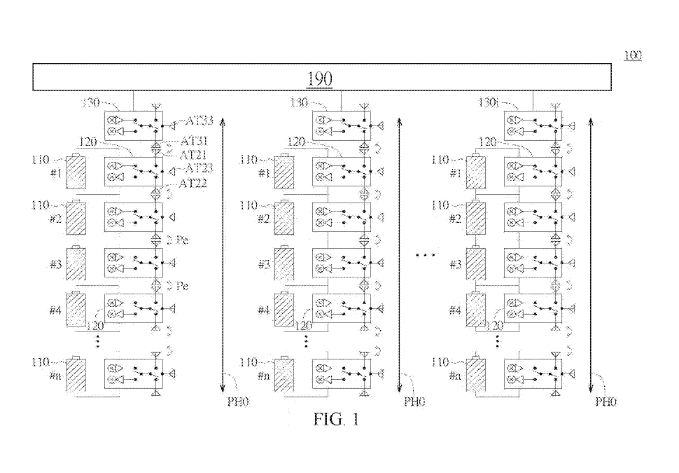

Referring to FIG. 1, a schematic diagram of a battery communication system 100 according to one embodiment of the present invention is illustrated. The battery communication system 100 includes, for example, multiple battery units 110, multiple slave wireless communication units 120, a master wireless communication unit 130, and a battery management unit 190. Each of the slave wireless communication units 120 is connected to a corresponding battery unit 110. Each slave wireless communication unit 120 includes two main communication antennas (AT21 and AT22), and one auxiliary communication antenna AT23. The master wireless communication unit 130 includes one main communication antenna AT31 and one auxiliary communication antenna AT33.

As shown in FIG. 1, the battery communication system 100 communicates with the multiple battery units 110 through the master wireless communication unit 130 and the slave wireless communication units 120. The master wireless communication unit 130 and the slave wireless communication units 120 are serially connected to form a wireless daisy chain communication path PH0. The main communication antenna AT31 of the master wireless communication unit 130 and the main communication antennas (AT21 and AT22) of the slave wireless communication units 120 form whisper communication paths Pe. Therein, the whisper communication paths Pe use electronic coupling waves EW or magnetic coupling waves MW for data transmission.

For example, a whisper communication path Pe is formed between the main communication antenna AT31 of the master wireless communication unit 130 and the main communication antenna AT21 of the slave wireless communication unit 120 labeled “#1”. A whisper communication path Pe is also formed between the main communication antenna AT22 of the slave wireless communication unit 120 labeled “#1” and the main communication antenna AT21 of the slave wireless communication unit 120 labeled “#2”, and so on. Each whisper communication path Pe allows communication only between two adjacent main communication antennas (AT21 and AT22).

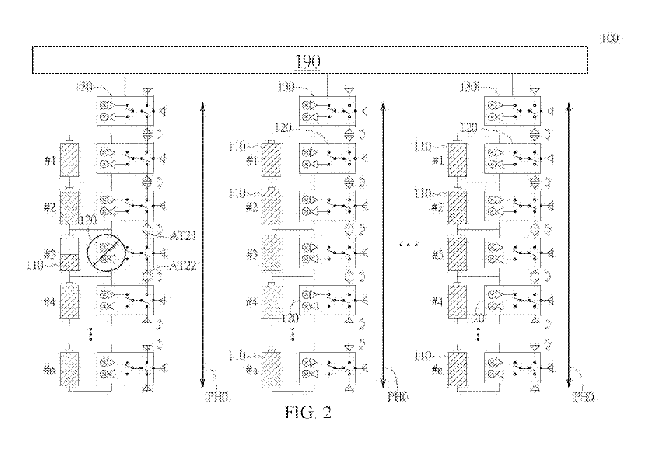

Referring to FIG. 2, one fault condition of the battery communication system 100 is explained, according to one embodiment of the present invention. In one situation, when one of the battery units 110 (or one of the slave wireless communication units 120) fails, the wireless daisy chain communication path PH0 is interrupted, such that the failed slave wireless communication unit 120 cannot transmit information to the next slave wireless communication unit 120 via the whisper communication path Pe, nor can it communicate with the master wireless communication unit 130.

For example, as shown in FIG. 2, when the battery unit 110 (or the slave wireless communication unit 120) labeled “#3” fails, the slave wireless communication unit 120 labeled “#4” cannot transmit information to the slave wireless communication unit 120 labeled “#3” via the whisper communication path Pe. Thus, the wireless daisy chain communication path PH0 is interrupted due to the failure of the slave wireless communication unit 120 labeled “#3”, and information cannot be further transmitted to the slave wireless communication unit 120 labeled “#2”, nor can it be delivered to the master wireless communication unit 130.

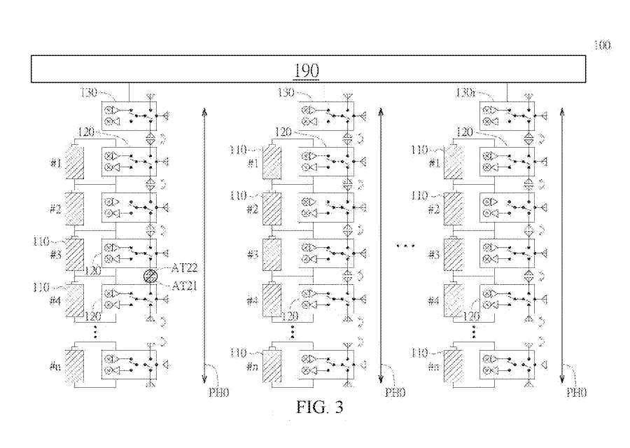

FIG. 3 illustrates another fault condition of the battery communication system 100 according to one embodiment of the present invention. In another situation, when a communication failure occurs between the main communication antennas (AT21 and AT22) of one of the slave wireless communication units 120, the wireless daisy chain communication path PH0 is interrupted, such that the failed main communication antennas AT21 or AT22 cannot continue to transmit information to other slave wireless communication units 120 via the whisper communication path Pe, nor can they communicate with the master wireless communication unit 130.

For example, referring to FIG. 3, when a communication failure occurs between the main communication antenna AT22 of the slave wireless communication unit 120 labeled “#3” and the main communication antenna AT21 of the slave wireless communication unit 120 labeled “#4”, the slave wireless communication unit 120 labeled “#4” cannot transmit information to the slave wireless communication unit 120 labeled “#3” via the whisper communication path Pe. Thus, the wireless daisy chain communication path PH0 is interrupted, and information cannot continue to be transmitted via the whisper communication path Pe to the slave wireless communication unit 120 labeled “#2”, nor can it be communicated to the master wireless communication unit 130.

Therefore, the present invention provides a specific solution for the various fault conditions described above, such that the battery communication system 100 can still maintain normal communication even when these fault conditions occur. The operation of the battery communication system 100 is described in detail below with reference to a flowchart.

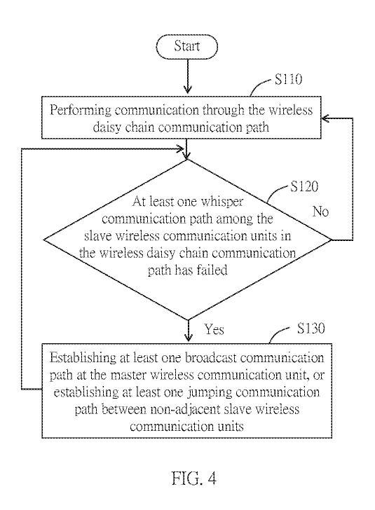

Referring to FIG. 4, a flowchart of an operation method of the battery communication system 100 according to one embodiment of the present invention is illustrated. The operation method of the battery communication system 100 includes steps S110 through S130. In the step S110, the communication is performed via the wireless daisy chain communication path PH0. In this step, the master wireless communication unit 130 and all of the slave wireless communication units 120 of the battery communication system 100 communicate via the whisper communication paths Pe.

Next, in the step S120, it is determined whether at least one whisper communication path Pe among the slave wireless communication units 120 in the wireless daisy chain communication path PH0 has failed. This step may be performed, for example, by the slave wireless communication units 120. After the slave wireless communication unit 120 sends a message to an adjacent slave wireless communication unit 120, no acknowledgment signal (ACK) is received backward, it indicates that the whisper communication path Pe has failed. Alternatively, this step may be performed by the master wireless communication unit 130. For example, when some received messages are missing, it indicates that the whisper communication path Pe has failed.

When any whisper communication path Pe has failed, the process proceeds to step S130; when no whisper communication path Pe has failed, the process returns to step S110 for establishing the wireless daisy chain communication path PH0.

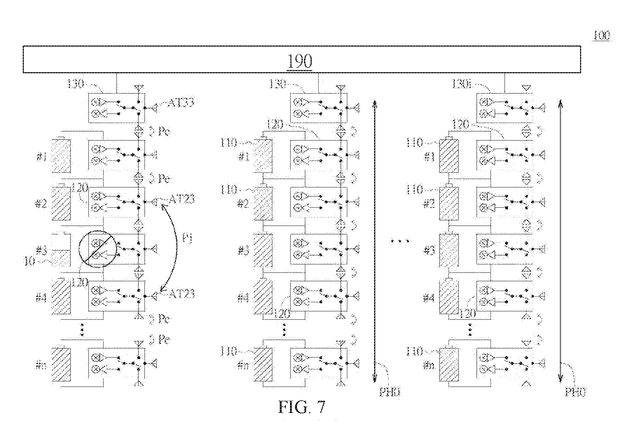

In the step S130, at least one broadcast communication path Pb is established at the master wireless communication unit 130, or at least one jumping communication path Pj (as shown in FIG. 7) is established between non-adjacent slave wireless communication units 120.

In this embodiment, the auxiliary communication antenna AT23 is used to form at least one broadcast communication path Pb or at least one jumping communication path Pj, as shown in FIG. 7. The signal strength of the broadcast communication path Pb is higher than that of the whisper communication path Pe. The broadcast communication path Pb may be, for example, a unidirectional communication path or a bidirectional communication path. The signal strength of the jumping communication path Pj is higher than that of the whisper communication path Pe. The jumping communication path Pj may be, for example, a unidirectional communication path or a bidirectional communication path. The battery communication system 100 may, for example, simultaneously employ at least one whisper communication path Pe and at least one broadcast communication path Pb; or simultaneously employ at least one whisper communication path Pe and at least one jumping communication path Pj; or simultaneously employ at least one broadcast communication path Pb and at least one jumping communication path Pj; or simultaneously employ at least one whisper communication path Pe, at least one jumping communication path Pj, and at least one broadcast communication path Pb.

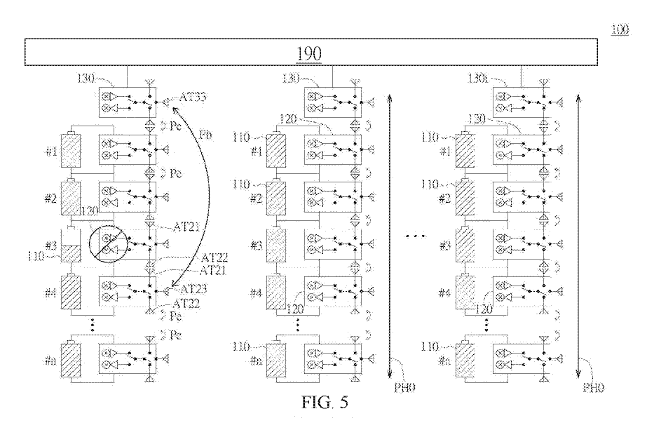

For example, referring to FIG. 5, one example of implementing the operation method of the battery communication system 100 shown in FIG. 4 is illustrated. In one embodiment, when the battery unit 110 (or the slave wireless communication unit 120) labeled “#3” fails, a bidirectional broadcast communication path Pb is established between the slave wireless communication unit 120 labeled “#4” and the master wireless communication unit 130. With establishing the bidirectional broadcast communication path Pb, the slave wireless communication units 120 labeled “#1” and “#2” can communicate bidirectionally with the master wireless communication unit 130 via the whisper communication paths Pe; the slave wireless communication unit 120 labeled “#4” can communicate bidirectionally with the master wireless communication unit 130 via the broadcast communication path Pb; and the slave wireless communication unit 120 labeled “#n” can communicate bidirectionally with the master wireless communication unit 130 via both of the whisper communication paths Pe and the broadcast communication path Pb. Thus, most communication paths can continue to operate normally without being blocked by the failure of the battery unit 110 (or the slave wireless communication unit 120) labeled “#3”.

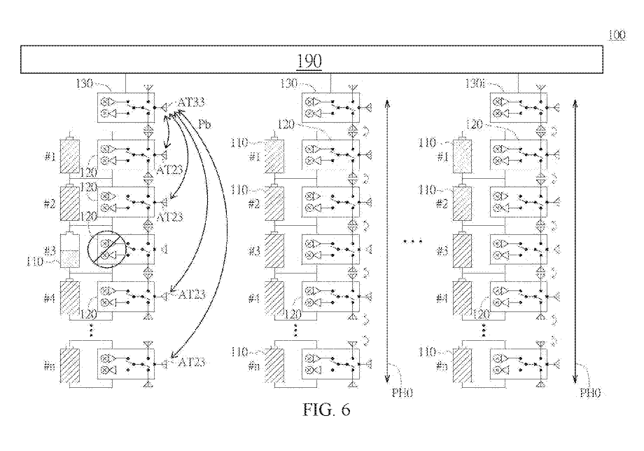

Referring to FIG. 6, another example of implementing the operation method of the battery communication system 100 shown in FIG. 4 is illustrated. When the battery unit 110 (or the slave wireless communication unit 120) labeled “#3” fails, the bidirectional broadcast communication paths Pb are established between all of the remaining slave wireless communication units 120 and the master wireless communication unit 130. After the bidirectional broadcast communication paths Pb are established, the slave wireless communication units 120 labeled “#1” through “#2”, and “#4” through “#n”, can communicate bidirectionally with the master wireless communication unit 130 via the broadcast communication paths Pb, so that most communication paths can operate normally without being blocked by the failure of the battery unit 110 (or the slave wireless communication unit 120) labeled “#3”.

Referring to FIG. 7, another example of implementing the operation method of the battery communication system 100 shown in FIG. 4 is illustrated. When the battery unit 110 (or the slave wireless communication unit 120) labeled “#3” fails, a bidirectional jumping communication path Pj is established between the slave wireless communication unit 120 labeled “#4” and the slave wireless communication unit 120 labeled “#2”. Since the signal strength of the jumping communication path Pj is higher than that of the original whisper communication path Pe, the jumping communication path Pj can bypass the slave wireless communication unit 120 labeled “#3”. With establishing the bidirectional jumping communication path Pj, the slave wireless communication units 120 labeled “#1” and “#2” can communicate bidirectionally with the master wireless communication unit 130 via the whisper communication paths Pe; the slave wireless communication unit 120 labeled “#4” can communicate bidirectionally with the master wireless communication unit 130 via the jumping communication path Pj and the whisper communication paths Pe; and the slave wireless communication unit 120 labeled “#n” can communicate bidirectionally with the master wireless communication unit 130 via the whisper communication paths Pe and the jumping communication paths Pj. Thus, most communication paths can continue to operate normally without being blocked by the failure of the battery unit 110 (or the slave wireless communication unit 120) labeled “#3”.

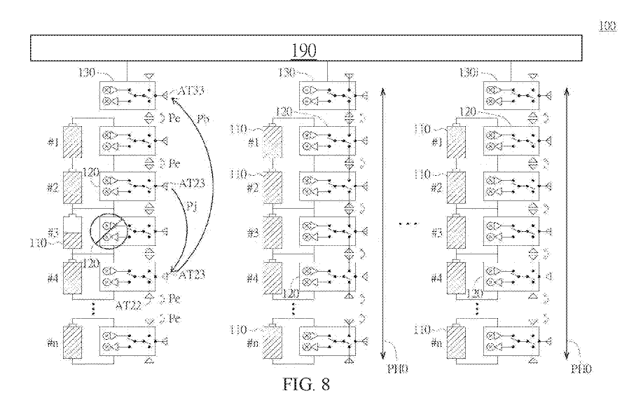

Referring to FIG. 8, another example of implementing the operation method of the battery communication system 100 shown in FIG. 4 is illustrated. When the battery unit 110 (or the slave wireless communication unit 120) labeled “#3” fails, a unidirectional jumping communication path Pj is established between the slave wireless communication unit 120 labeled “#4” and the slave wireless communication unit 120 labeled “#2”, and a unidirectional broadcast communication path Pb is established between the slave wireless communication unit 120 labeled “#4” and the master wireless communication unit 130. With establishing the unidirectional jumping communication path Pj and the unidirectional broadcast communication path Pb, the slave wireless communication units 120 labeled “#1” and “#2” can communicate bidirectionally with the master wireless communication unit 130 via the whisper communication paths Pe; the slave wireless communication unit 120 labeled “#4” can receive information from the master wireless communication unit 130 via the whisper communication paths Pe and the jumping communication path Pj, and can transmit information to the master wireless communication unit 130 via the broadcast communication path Pb; the slave wireless communication unit 120 labeled “#n” can receive information from the master wireless communication unit 130 via the whisper communication paths Pe and the jumping communication path Pj, and can transmit information to the master wireless communication unit 130 via the whisper communication paths Pe and the broadcast communication path Pb. Thus, most communication paths can continue to operate normally without being blocked by the failure of the battery unit 110 (or the slave wireless communication unit 120) labeled “#3”.

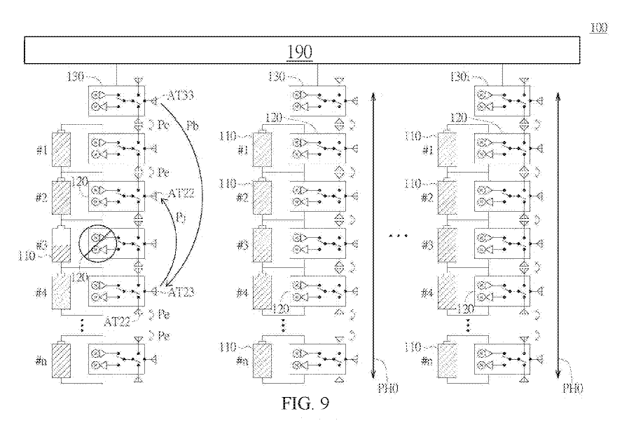

Referring to FIG. 9, another example of implementing the operation method of the battery communication system 100 shown in FIG. 4 is illustrated. When the battery unit 110 (or the slave wireless communication unit 120) labeled “#3” fails, a unidirectional jumping communication path Pj is established between the slave wireless communication unit 120 labeled “#4” and the slave wireless communication unit 120 labeled “#2”, and a unidirectional broadcast communication path Pb is established between the slave wireless communication unit 120 labeled “#4” and the master wireless communication unit 130. After the unidirectional jumping communication path Pj and the unidirectional broadcast communication path Pb are established, the slave wireless communication units 120 labeled “#1” and “#2” can communicate bidirectionally with the master wireless communication unit 130 via the whisper communication paths Pe; the slave wireless communication unit 120 labeled “#4” can receive information from the master wireless communication unit 130 via the broadcast communication path Pb and can transmit information to the master wireless communication unit 130 via the jumping communication path Pj and the whisper communication paths Pe; the slave wireless communication unit 120 labeled “#n” can receive information from the master wireless communication unit 130 via the whisper communication paths Pe and the broadcast communication path Pb, and can transmit information to the master wireless communication unit 130 via the whisper communication paths Pe and the jumping communication path Pj. Thus, most communication paths can continue to operate normally without being blocked by the failure of the battery unit 110 (or the slave wireless communication unit 120) labeled “#3”.

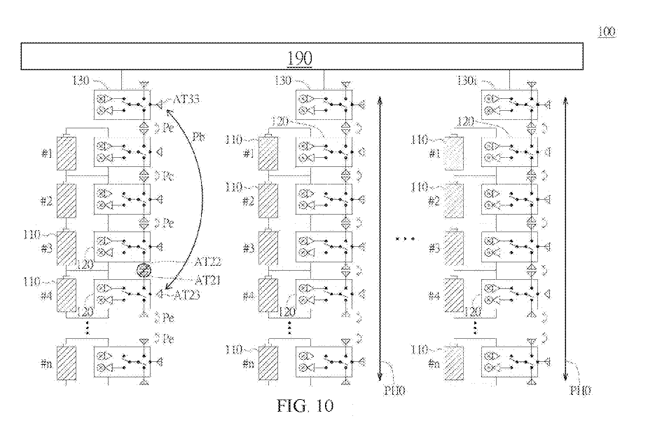

Referring to FIG. 10, another example of implementing the operation method of the battery communication system 100 shown in FIG. 4 is illustrated. When a communication malfunction occurs between the main communication antenna AT22 of the slave wireless communication unit 120 labeled “#3” and the main communication antenna AT21 of the slave wireless communication unit 120 labeled “#4”, a bidirectional broadcast communication path Pb is established between the slave wireless communication unit 120 labeled “#4” and the master wireless communication unit 130. After the bidirectional broadcast communication path Pb is established, the slave wireless communication units 120 labeled “#1” and “#2” can communicate with the master wireless communication unit 130 via the whisper communication path(s) Pe; and the slave wireless communication units 120 labeled “#4” and “#n” can communicate bidirectionally with the master wireless communication unit 130 via the broadcast communication path Pb. Thus, the communication paths between the communication units can continue to operate normally without being blocked by a malfunction in one of the whisper communication paths Pe.

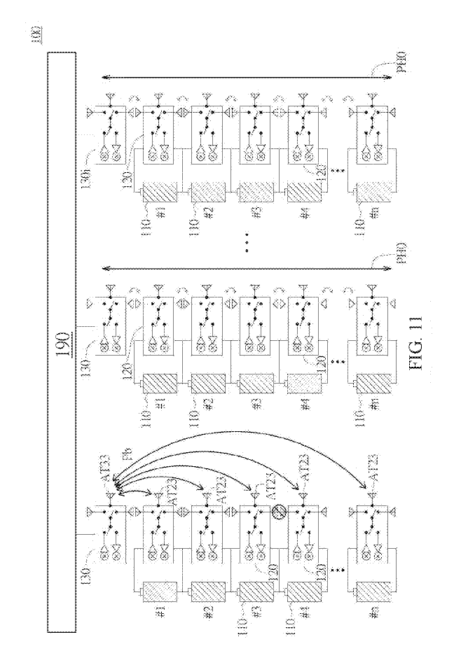

Referring to FIG. 11, another example of implementing the operation method of the battery communication system 100 shown in FIG. 4 is illustrated. When a communication malfunction occurs between the main communication antenna AT22 of the slave wireless communication unit 120 labeled “#3” and the main communication antenna AT21 of the slave wireless communication unit 120 labeled “#4”, the bidirectional broadcast communication paths Pb are established between the auxiliary communication antennas of all slave wireless communication units 120 and the master wireless communication unit 130. After the bidirectional broadcast communication paths Pb are established, all slave wireless communication units 120 can communicate bidirectionally with the master wireless communication unit 130 via the broadcast communication paths Pb, so that the communication paths can continue to operate normally without being blocked by a malfunction in any whisper communication path Pe.

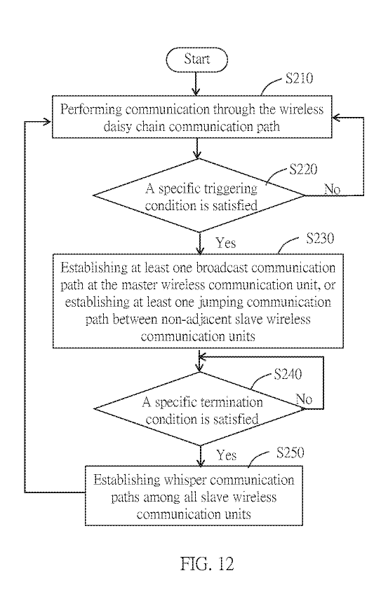

Referring to FIG. 12, a flowchart illustrating an operation method of the battery communication system 100 according to another embodiment of the present invention is shown. In this embodiment, the operation method further includes steps S210 through S250 in comparison with the operation method shown in FIG. 4. In the step S210, communication is performed via the wireless daisy chain communication path PH0. In this step, the master wireless communication unit 130 and all slave wireless communication units 120 of the battery communication system 100 communicate via the whisper communication paths Pe.

Next, in the step S220, it is determined whether a specific triggering condition is satisfied. The specific triggering condition may include, for example, at least one whisper communication path Pe of the slave wireless communication units 120 failing, or the master wireless communication unit 130 receiving a broadcast switch signal SW (shown in FIG. 12) or a jumping switch signal (not shown). When the specific triggering condition is not satisfied, the process returns to step S210. When the specific triggering condition is satisfied, the process proceeds to step S230.

In the step S230, at least one broadcast communication path Pb is established at the master wireless communication unit 130, or at least one jumping communication path Pj is established between non-adjacent slave wireless communication units 120.

Next, in the step S240, it is determined whether a specific termination condition is satisfied. The specific termination condition may include, for example, the master wireless communication unit 130 receiving a whisper switch signal (not shown), or the whisper communication paths Pe being restored. When the specific termination condition is satisfied, the process proceeds to step S250.

In the step S250, the whisper communication paths Pe are established among all slave wireless communication units 120. The examples of implementation are described below.

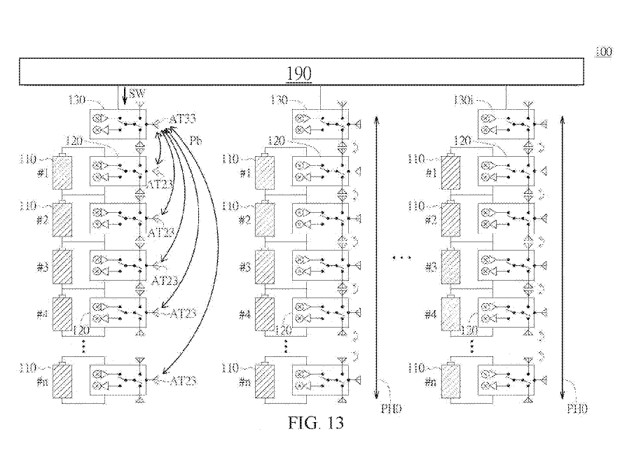

Referring to FIG. 13, one example of implementing the operation method of the battery communication system 100 shown in FIG. 12 is illustrated. In the example of FIG. 13, a user can send a broadcast switch signal SW to the master wireless communication unit 130 through the battery management unit 190. After receiving the broadcast switch signal SW, the master wireless communication unit 130 notifies all slave wireless communication units 120 and establishes bidirectional broadcast communication paths Pb between all slave wireless communication units 120 and the master wireless communication unit 130.

Similarly, the user can send a whisper switch signal (not shown) to the master wireless communication unit 130 through the battery management unit 190. After receiving the whisper switch signal (not shown), the master wireless communication unit 130 notifies all slave wireless communication units 120 and establishes bidirectional whisper communication paths Pe among all slave wireless communication units 120.

Similarly, the user can send a jumping switch signal (not shown) to the master wireless communication unit 130 through the battery management unit 190. After receiving the jumping switch signal (not shown), the master wireless communication unit 130 notifies specific slave wireless communication units 120 and establishes jumping communication paths Pj for those specific slave wireless communication units 120.

Through the above embodiments, when battery damage, communication abnormalities, or specific needs occur, the battery communication system 100 can use broadcast communication paths Pb or jumping communication paths Pj to replace some of the whisper communication paths Pe, so that communication can continue to operate normally without being severely affected by failures.

The present invention has been disclosed with reference to the above embodiments, which are not intended to limit the spirit and scope of the present invention. A person skilled in the art to which the present disclosure pertains may make various modifications and adjustments without departing from the spirit and scope of the present disclosure. Accordingly, the scope of protection of the present invention can be defined by the claims.

What is claimed is:

1. An operation method of a battery communication system, for communicating with a plurality of battery units through a master wireless communication unit and a plurality of slave wireless communication units, each of the battery units being connected to a respective one of the slave wireless communication units, the operation method including:
determining whether a specific triggering condition is satisfied in a wireless daisy chain communication path of the battery communication system; and
when the specific triggering condition is satisfied, establishing at least one broadcast communication path at the master wireless communication unit, or establishing at least one jumping communication path between non-adjacent two of the slave wireless communication units.

2. The operation method of the battery communication system according to claim 1, wherein the specific triggering condition includes at least one of: a failure occurring in at least one whisper communication path of the slave wireless communication units; the master wireless communication unit receiving a broadcast switch signal; or the master wireless communication unit receiving a jumping switch signal.

3. The operation method of the battery communication system according to claim 2, wherein a signal strength of the at least one broadcast communication path is higher than a signal strength of the at least one whisper communication path.

4. The operation method of the battery communication system according to claim 2, wherein a signal strength of the at least one jumping communication path is higher than a signal strength of the at least one whisper communication path.

5. The operation method of the battery communication system according to claim 1, wherein the at least one broadcast communication path is a unidirectional communication path.

6. The operation method of the battery communication system according to claim 1, wherein the at least one broadcast communication path is a bidirectional communication path.

7. The operation method of the battery communication system according to claim 1, wherein the at least one jumping communication path is a unidirectional communication path.

8. The operation method of the battery communication system according to claim 1, wherein the at least one jumping communication path is a bidirectional communication path.

9. The operation method of the battery communication system according to claim 1, wherein the battery communication system simultaneously employs at least one whisper communication path and the at least one broadcast communication path.

10. The operation method of the battery communication system according to claim 1, wherein the battery communication system simultaneously employs at least one whisper communication path and the at least one jumping communication path.

11. The operation method of the battery communication system according to claim 1, wherein the battery communication system simultaneously employs the at least one broadcast communication path and the at least one jumping communication path.

12. The operation method of the battery communication system according to claim 1, wherein the battery communication system simultaneously employs at least one whisper communication path, the at least one broadcast communication path, and the at least one jumping communication path.

13. A battery communication system, including:
a plurality of battery units;
a plurality of slave wireless communication units, each of the slave wireless communication units being connected to a respective one of the battery units; and
a master wireless communication unit, the master wireless communication unit and the slave wireless communication units being serially connected to form a wireless daisy chain communication path;
wherein, when a specific triggering condition is satisfied, at least one broadcast communication path at the master wireless communication unit is established, or at least one jumping communication path is established between non-adjacent two of the slave wireless communication units.

14. The battery communication system according to claim 13, wherein the specific triggering condition includes at least one of: a failure occurring in at least one whisper communication path of the slave wireless communication units; the master wireless communication unit receiving a broadcast switch signal; or the master wireless communication unit receiving a jumping switch signal.

15. The battery communication system according to claim 14, wherein a signal strength of the at least one broadcast communication path is higher than a signal strength of the at least one whisper communication path.

16. The battery communication system according to claim 14, wherein a signal strength of the at least one jumping communication path is higher than a signal strength of the at least one whisper communication path.

17. The battery communication system according to claim 13, wherein each of the slave wireless communication units includes:
two main communication antennas, each of the main communication antennas being configured to form at least one whisper communication path; and
one auxiliary communication antenna, configured to form the at least one broadcast communication path or the at least one jumping communication path.

18. The battery communication system according to claim 13, wherein the master wireless communication unit includes:
one main communication antenna, configured to form at least one whisper communication path; and
one auxiliary communication antenna, configured to form the at least one broadcast communication path or the at least one jumping communication path.
